(19) United States
(12) Patent Application Publication
(10) Pub. No.: US 2024/0412616 A1
(43) Pub. Date: Dec. 12, 2024

(54) SYSTEMS AND DEVICES FOR MAINTAINING A COMMUNICABLE RELATIONSHIP BETWEEN AN INDICIA READER AND A HOST

(71) Applicant: ZEBRA TECHNOLOGIES CORPORATION, Lincolnshire, IL (US)

(72) Inventors: Mariya Wright, Cortland Manor, NY (US); NIna Feinstein, Hicksville, NY (US); John P. Evans, Levittown, NY (US)

(21) Appl. No.: 18/208,692

(22) Filed: Jun. 12, 2023

(51) Int. Cl. G08B 21/18; G06K 7/14; H04B 17/318

(52) U.S. Cl. CPC G08B 21/18; G06K 7/1404; H04B 17/318

(57) ABSTRACT

Embodiments of the present disclosure relate to generating alert signals based on wireless signal strength measurements between data capture devices, like indicia readers or other mobile devices, and their respective hosts, like their charge cradles. An example method that utilizes this approach includes determining a received signal strength indicator (RSSI) of a wireless signal between a mobile device and a host. This determination may be made on either the mobile device or the host. From there, if the RSSI falls within a first RSSI range associated with generating a first alert signal, at least one of the mobile device or the host generates a first alert via its respective alert module. On the other hand, if the RSSI falls within a second RSSI range, at least one of the mobile device or the host generates a second alert via its respective alert module.

### BACKGROUND

Today, the use of indicia readers, like barcode readers, throughout retail environments is ubiquitous with such use being seen not only by venue employees, but also by end-users as kiosks and self-checkout stations. However, with such prolific use come concerns of loss of said readers, particularly in instances where end-users operate handheld indicia readers at points that are close to venue exists, like self-checkout station. Whether by choice or inadvertently, but it is not uncommon for an end-user to leave the venue with a handheld reader. Such loss can be doubly costly as it creates the need to acquire a replacement device and disrupts normal operations for other would-be users.

Solutions to this problem, thus far, have relied on generating alerts when the indicia readers and hosts lose connectivity. However, in practice this approach is problematic as most short-range communication protocols that use used for reader/host communication protocols have a long-enough range such that a user carrying an indicia reader could easily leave the premises of the venue and still have the reader maintain its connection to the host. As a result, there exists a need for improved systems, devices, and methods for identifying instances of when an indicia reader (or another mobile device) is leaving a desired perimeter and providing an appropriate indication.

### SUMMARY

Accordingly, at least some embodiments described in the present disclosure are related to systems, devices, and methods for identifying instances of when an indicia reader (or another mobile device) is leaving a desired perimeter and providing an appropriate indication.

Some embodiments of the present disclosure are directed to an indicia reader configured to communicate wirelessly with a host. In this embodiment, the indicia reader includes: an imaging assembly for capturing image data over a field of view; a decode module for receiving the image data and extracting a payload of an indicium present in the image data; a wireless radio for transmitting the payload to the host; a controller; and a memory storing computer readable instructions that. When the instructions are executed by the controller, it cause the controller to: determine a received signal strength indicator (RSSI) of a wireless signal between the indicia reader and the host; responsive to the RSSI being within a first RSSI range associated with generating a first alert signal, at least one of (i) generating a first alert via an alert module of the indicia reader or (ii) transmitting a first alert message to the host; and responsive to the RSSI being within a second RSSI range associated with generating a second alert signal, at least one of (i) generating a second alert via the alert module of the indicia reader or (ii) transmitting a second alert message to the host.

Some embodiments of the present disclosure are directed to a system which includes: an indicia reader configured to communicate wirelessly with a host, and the host. The indicia reader includes: an imaging assembly for capturing image data over a field of view; a decode module for receiving the image data and extracting a payload of an indicium present in the image data; a reader wireless radio for transmitting the payload to the host; a reader controller; and a reader memory storing computer readable instructions that, when executed by the reader controller, cause the reader controller to: determine a received signal strength indicator (RSSI) of a wireless signal between the indicia reader and the host; responsive to the RSSI being within a first RSSI range associated with generating a first alert signal, at least one of (i) generating a first alert via an alert module of the indicia reader or (ii) transmitting a first alert message to the host; and responsive to the RSSI being within a second RSSI range associated with generating a second alert signal, at least one of (i) generating a second alert via the alert module of the indicia reader or (ii) transmitting a second alert message to the host. The host, which is communicatively coupled to the indicia reader, includes: a host wireless radio for receiving the payload from the indicia reader.

Some embodiments of the present disclosure are directed to a system that includes: an indicia reader configured to communicate wirelessly with a host, and the host. The indicia reader includes: an imaging assembly for capturing image data over a field of view; a decode module for receiving the image data and extracting a payload of an indicium present in the image data; a reader wireless radio for transmitting the payload to the host; and the host communicatively coupled to the indicia reader. The host includes: a host wireless radio for receiving the payload from the indicia reader; a host controller; and a host memory storing computer readable instructions that, when executed by the host controller, cause the host controller to: determine a received signal strength indicator (RSSI) of a wireless signal between the indicia reader and the host; responsive to the RSSI being within a first RSSI range associated with generating a first alert signal, at least one of (i) generating a first alert via an alert module of the host or (ii) transmitting a first alert message to the indicia reader; and responsive to the RSSI being within a second RSSI range associated with generating a second alert signal, at least one of (i) generating a second alert via the alert module of the host or (ii) transmitting a second alert message to the indicia reader.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIGS. 1A and 1B illustrate an example indicia reader with FIG. 1B showing the example indicia reader docked in an example a host cradle for implementing various aspects of the present disclosure.

FIG. 2 illustrates an example block diagram of the indicia reader and cradle/host of FIGS. 1A and 1B.

FIGS. 3 and 4 illustrate the indicia reader of FIGS. 1A and 1B being exemplarily used in a self-checkout environment.

FIG. 5 illustrates an example RSSI versus distance chart representative of the RSSI values between the reader and cradle of FIGS. 1A and 1B.

FIG. 6 illustrates a flowchart representative of an example method of providing an alert in accordance with an embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As used herein, the term “indicia” should be understood to refer to any kind of visual marker that can be associated with an item or a transaction. For example, indicia can be a 1D, 2D, or 3D barcode, a graphic, a logo, etc. Additionally, indicia may comprise encoded payload data as, for example, is the case with a 1D or 2D barcode where the barcode encodes a payload comprised of, for example, alphanumeric or special characters that may be formed into a string.

It has been recognized that due to periodic loss of handheld indicia readers there exists a need for improved approaches to providing an indication of an oncoming loss of the reader. This could be particularly useful in retail environments where end-users like consumers who are checking out items at a self-checkout station may tend to, intentionally or unintentionally, walk out of the venue with the reader in hand.

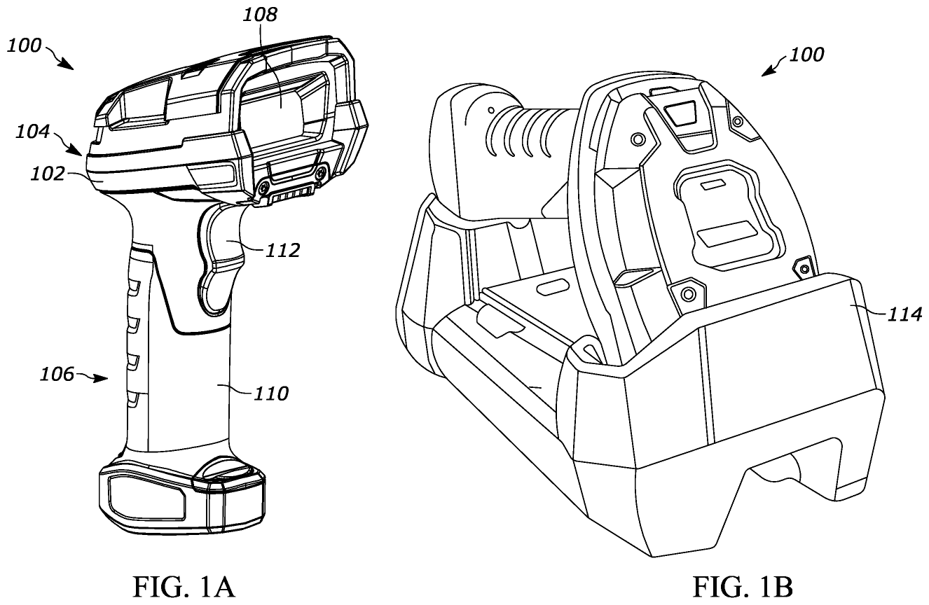

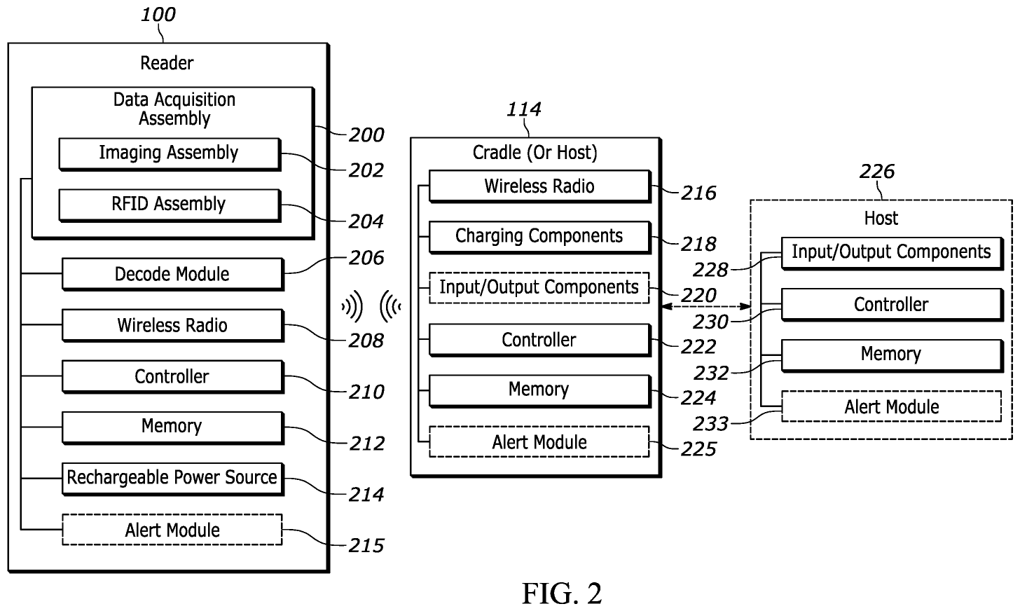

At a higher level, embodiments described herein may be used in connection with a variety of wireless indicia readers. Additionally, the same concepts may also be applied to other mobile devices that may or may not necessarily have indicia-reading capabilities. FIGS. 1A and 1B illustrate one example of such indicia reader 100 with said reader being shown in an upright position in FIGS. 1A and 1n a docked position in FIG. 1B. Reader 100 generally includes a housing 102 that is comprised of a head portion 104 and a bottom portion 106. The head portion 104 houses at least some optoelectrical components for capturing relevant image data along a FOV that extends through a window 108. The bottom portion 106 typically includes a handle portion 110 that houses a batter or any rechargeable power source (see rechargeable power source 214 in FIG. 2) and a trigger 112. In operation, a user typically grasps the handle portion 110 and points the reader 100 in a general direction of the indicia that is to be read. If the reader is configured to be activated with the activation of the trigger 112, subsequent to the user squeezing the trigger 112, reader 100 captures relevant image data and processes it accordingly. When not in use, the reader 100 can be placed in a cradle 114 to charge the battery.

FIG. 2 illustrates a block diagram representative of the functional modules of the reader 100 and the cradle 114. Namely, reader 100 includes a data acquisition assembly 200 that may include an imaging assembly 202 operable to capture image data associated with an item bearing an indicium and/or a Radio Frequency Identification (RFID) assembly 204 operable to capture data embedded in an RFID tag by interrogating said tag pursuant to known RFID communication protocols. In instances where the reader includes the imaging assembly, such assembly may include one or more 2D or 3D image sensor along with corresponding lens optics for forming a field of view over which image data is captured by the respective image sensor. In instances of the imaging assembly being a 2D imaging assembly, it may include an image sensor (also referred to as an imager or imaging sensor) that can be, for example, a two-dimensional CCD or a CMOS sensor that can be either a monochrome sensor or a color sensor having, for instance 1.2 megapixels arranged in a 1200×960 pixel configuration. It should be appreciated that sensors having other pixel-counts (both below and above) are within the scope of this disclosure. These two-dimensional sensors generally include mutually orthogonal rows and columns of photosensitive pixel elements arranged to form a substantially flat square or rectangular surface. Such imagers are operative to detect light captured by an imaging lens assembly along a respective optical path or axis that normally traverses through the window of the reader.

Under typical operation, image data captured by the imaging assembly 202 is passed to the reader's decode module 206 where that image data undergoes image analysis to detect and decode an indicium that is present in that image data. This results in the payload of the indicium. A similar payload may be obtained via the RFID assembly from an RFID tag associated with an item. Once decoded or obtained otherwise, the payload is transmitted via the reader's wireless radio 208 to the cradle 114 using a wireless communication protocol like, for example a short-range wireless communication protocol such as Bluetooth or Wi-Fi. This functionality of the reader 100 is generally implemented through a controller 210 pursuant to executable instructions stored in the reader's memory 212.

On the cradle-side the payload data is received by the cradle's wireless radio 216. In addition to the wireless radio, the cradle further includes charging components 218 for supplying power to the rechargeable power source 214 of the reader 100 and a controller 222 which controls various functional aspects of the cradle 114 by executing instructions stores in the cradle's memory 224.

It should be appreciated that often a reader/cradle combination of FIGS. 1A and 1B will further be interfaced with a host 226 like, for example, a point-of-sale (POS) computer, a backend server, or any other type of host. In this way, a consumer may read a barcode via reader 100, the payload of that barcode can be transmitted to the cradle 114, where it can further be transmitted to a POS computer for further transaction operations. Typically, the exchange of data between the cradle 114 and the host 226 takes place over a wired and/or wireless network through the use of I/O components 220 and I/O Components 228, where the functional aspects of the host 226 are controlled by a respective controller 230 which executes instructions stored in the host's memory 232.

Still, in other instances the cradle 114 may be replaced by a host, like a host 226. As a practical example, such an arrangement may exist where it is desired for the reader 100 to interface directly with a host like a wireless-enables PC, tablet, mobile phone, or the like. While in this instance, power for the rechargeable power source 214 will likely have to be obtained elsewhere, functional aspects related to data transfer and device detection, as described further in this disclosure, are equally applicable.

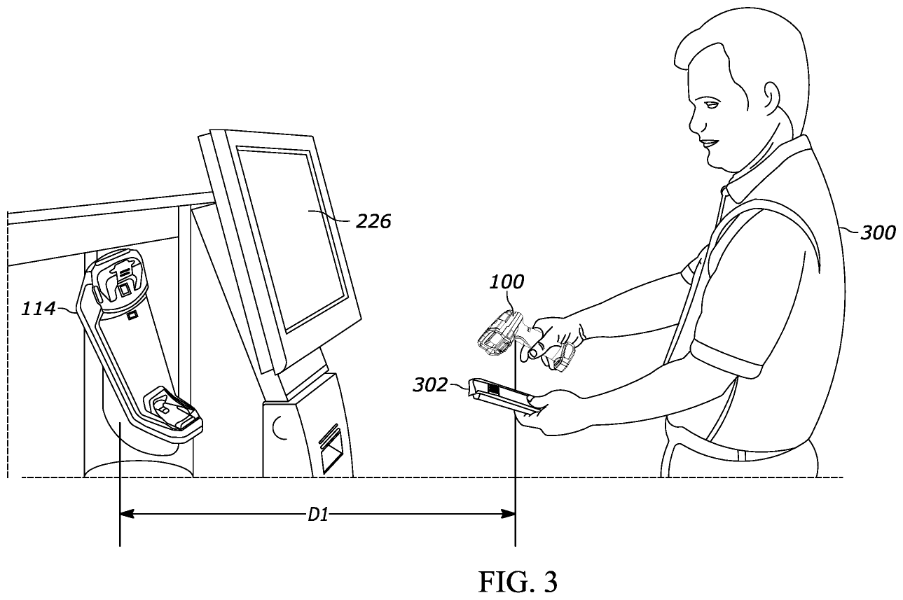

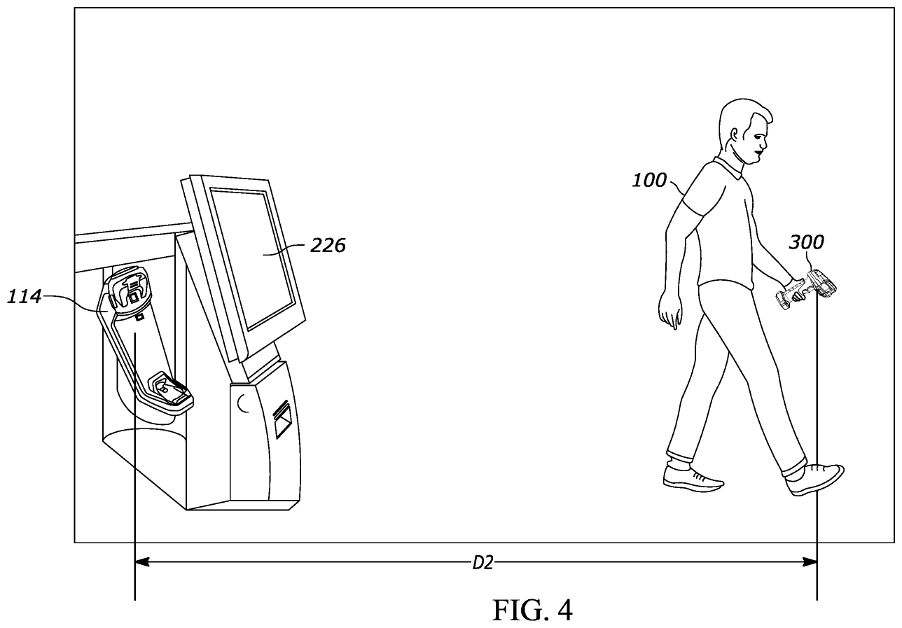

Turning now to FIG. 3, shown therein is an exemplary instance of a consumer 300 engaged in a self-checkout process whereby the consumer is using the reader 100 to read an indicium affixed to an item 302. As described above, the reader 100 decodes the indicia and transmits its payload to the cradle 114 which is communicatively coupled to the POS host 226. In this instance, the consumer is standing such that the reader 100 is a relatively close distance D1 from the cradle. The same user 300 is illustrated in FIG. 4. However, in this instance the user 300 is shown as walking away from the POS host 226 and the cradle 114 with the reader 100 in hand. As a result, the distance between the reader 100 and its cradle 114 has increased from a relatively close D1 to a relatively far D2.

It has been recognized that such variances in distance translate into measurable Received Signal Strength Indicator (RSSI) values and that these measured values can be used to provide an alert when the distance between the reader 100 and the cradle 114 (or its respective host) reaches and/or exceeds a predetermined limit. Additionally, to avoid a sudden onset of a relatively notable alert resulting in user annoyance, said alert can be provided on a graduated scale beginning with, for example a low chime upon reaching a first level of RSSI and escalating into a relatively noticeable and loud high-frequency tone.

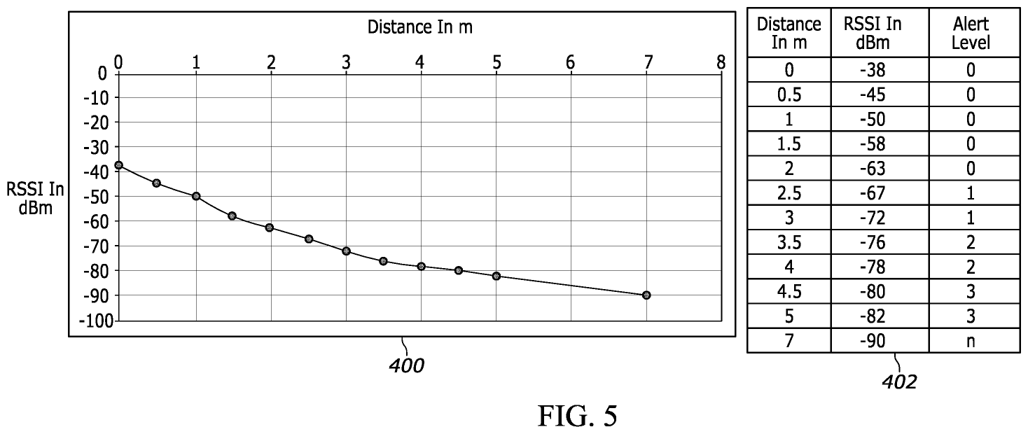

FIG. 5 illustrates an exemplary RSSI in dBm versus distance in meters chart 400 along with a corresponding table 402. Using these values as an example of RSSI values measured by the reader 100 that is communicatively coupled to a cradle 114 via the Bluetooth protocol, one can appreciate that operating the reader 100 within a relatively close range of us to 2 meters from the cradle 114 maintains the RSSI level at or above −63 dBm. Assuming that this distance range is determined to be an acceptable range for normal operation where no alert is required and the user is assumed to be using the reader 100 for its intended purpose, the reader 100 and/or cradle 114 can be configured to provide no alerts responsive to the RSSI being at or above −63 dBm. This is illustrated in the table with the alert level of 0.

Along those lines, it may be determined that once the distance between the reader 100 and the cradle 114 begins to exceed 2 meters, the likelihood that a user may be walking away from the cradle with the scanner in-hand may be increasing. However, at the same time it is still quite possible that the user simply moved beyond the 2-meter range inadvertently and intends to return to the sub-2-meter range shortly. In this instance it may be desirable to provide a low-level type of an alert designed to alert the user that they may be moving away from the cradle while holding the scanner. As an example, this alert may be a gentle chime, a low-volume audio beep, low-level haptic vibration, and/or some level of activation of the illumination assembly.

It should be appreciated that in some embodiments these alerts are configured to be provided on the reader 100 via the alert module 215 (see FIG. 2). In some embodiments, these alerts may be provided on the cradle 114/host via alert module 225. In some embodiments, these alerts may be further passed downstream beyond the cradle 114/host. Additionally, any combination of the foregoing alert configurations may be implemented and those of ordinary skill will appreciate that some alerts like, for example, those which are provided on the reader 100, may be geared more words drawing the attention of the user for that user to realize that they may, inadvertently, be moving away from the cradle with the reader in-hand. Other alerts like, for example, alerts on the cradle 114 or host, may be geared more towards drawing the attention of the venue employees for further intervention by said employees in the event that a user is leaving the premises with the reader 100.

Returning to the instance of the user moving beyond the 2-meter range, at this stage it may be desirable to provide a first-level alert. However, this level should continue (and not increase) so long as the user does not go beyond a corresponding range. In this example, this range is set as greater than 2 meters and less than or equal to 3 meters. As can be ascertained from the data of FIG. 5, in this range the RSSI is measured at less than −63 dBm and greater than or equal to −72 dBm. Conversely, when the measured RSSI falls within this value range, it can be correlated to falling with the greater than 2 meters and less than or equal to 3 meters range.

If the user returns to the sub-2-meter range, the alert level is adjusted accordingly to level zero. However, if the user continues to move away from the cradle 114 and proceeds beyond the 3-meter range, the alert level can be increased from level 2 to level 3. In this configuration, the alerts may be designed to draw greater attention to the fact that the distance between the reader 100 and the cradle 114 is increasing. Such alerts can include, for example, a relatively louder auditory tone, a relatively stronger haptic vibration, an alert on a device visible to the venue employee, and/or visual alerts like activation of visual beacon(s). As can be appreciated from the data of FIG. 5, the transition to alert level 2 can be set to occur when the measured RSSI is less than −72 dBm and greater than −78 dBm as this range of RSSI values corresponds to the greater than 3-meter and less than or equal to 4-meter range.

Similar to above, if the distance of the reader continues to increase to that of beyond the 4-meter range, the alert level can be increased to level 3, as shown in the table 402 of FIG. 5. This alert level corresponds to the distance range of greater than 4 meters and less than or equal to 5 meters and has an associated RSSI measurement of less than −78 dBm and greater than −82 dBm. Although the distances, RSSI, and alert level values used herein are merely exemplary, one can appreciate that under normal self-checkout use of a reader 100 it is relatively unlikely that the distance between the reader and the cradle will be in the 4-to −5 meter range and that is the distance has increased to this range the likelihood that a user is potentially walking out of the venue with the reader in-hand is relatively high. Consequently, at this point the alert(s) generated may be geared considerably more towards calling a high level of attention to the user and those around (particularly venue employees) so that the user may be observed and/or appropriate action may be taken, which may include, for example, notifying the user that they are still in possession of venue property (i.e., the reader) and that they must relinquish it before leaving the venue.

Along the same lines, an alert level n is configured to be activated once the distance between the reader 100 and the cradle 114/host reaches, for example, 7 meters. As is evident from FIG. 5, this is associated with the RSSI value of −90 or less. It may be determined that at the example distance of 7 meters it is very likely that the user that is holding the reader 100 will leave the venue with that reader in-hand. At this point, alert level n may be configured to be a maximum alert level designed to make it readily apparent, to the user, those around, and/or venue employees, that the user in possession of the reader 100 is likely to leave the venue premises with the reader. At this point, the alert(s) may include a relatively loud and audible auditory tone like a high frequency beep (at the reader, cradle and/or host, and/or employee station), one or more highly visible messages transmitted to a venue employee, activation of highly visible visual beacons, etc. This can help allow venue employees take appropriate action and prevent the loss of the reader 100.

Although the data of FIG. 5 illustrates four active levels of alerts (i.e., level 1, 2, 3, and n), this number may be adjusted as desired and, in some embodiments, any plurality of alerts may be set to occur based on corresponding RSSI values as those values correspond to respective distance ranges. It should further be appreciated that these ranges and types of alerts may be user-configurable via, for example, reader configuration software like, Zebra Technologies' 123Scan.

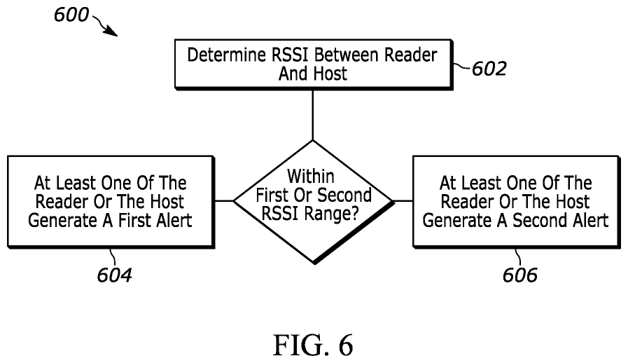

The device and system configurations described herein may be used to implement a method of generating an alert responsive to an indicia reader and a host being positioned within a range of each other. An example of such method is provided via a representative flowchart 600 of FIG. 6. As shown therein, the method includes determining 602 a received signal strength indicator (RSSI) of a wireless signal between the indicia reader and the host. This determination may be made on either the reader 100 or the cradle 114/host. From there, if the RSSI falls within a first RSSI range 604 associated with generating a first alert signal, at least one of the reader 100 or the cradle 114/host generates a first alert via its respective alert module. On the other hand, if the RSSI falls within a second RSSI range 606, at least one of the reader 100 or the cradle 114/host generates a second alert via its respective alert module. It will be appreciated that all functional aspects described above with respect to the various components of this disclosure may further be implemented as part of the method of FIG. 6.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An indicia reader configured to communicate wirelessly with a host, the indicia reader comprising:
an imaging assembly for capturing image data over a field of view;
a decode module for receiving the image data and extracting a payload of an indicium present in the image data;
a wireless radio for transmitting the payload to the host;
a controller; and
a memory storing computer readable instructions that, when executed by the controller, cause the controller to:
determine a received signal strength indicator (RSSI) of a wireless signal between the indicia reader and the host;
responsive to the RSSI being within a first RSSI range associated with generating a first alert signal, at least one of (i) generating a first alert via an alert module of the indicia reader or (ii) transmitting a first alert message to the host; and
responsive to the RSSI being within a second RSSI range associated with generating a second alert signal, at least one of (i) generating a second alert via the alert module of the indicia reader or (ii) transmitting a second alert message to the host.

2. The indicia reader of claim 1, wherein the host is a charging cradle configured to provide power to a rechargeable power source of the indicia reader.

3. The indicia reader of claim 1, wherein:
the first alert signal provides at least one of a first audible alert, a first visual alert, or a first haptic alert;
the second alert signal provides at least one of a second audible alert, a second visual alert, or a second haptic alert;
each of the second audible alert, the second visual alert, or the second haptic alert has a greater intensity than a respective one of the first audible alert, the first visual alert, or the first haptic alert.

4. The indicia reader of claim 1, wherein:
the second alert signal is configured to generate an alert of relatively higher intensity than first alert signal.

5. The indicia reader of claim 4, wherein the first RSSI range is further associated with a first distance range between the indicia reader and the host,
wherein the second RSSI range is further associated with a second distance range between the indicia reader and the host, and
wherein the second distance range extends over longer distances than the first distance range.

6. The indicia reader of claim 1, wherein the memory further stores computer readable instructions that, when executed by the controller, cause the controller to:
identify a transition to a measured RSSI being within one of the first range or the second range; and
responsively generating a respective one of the first alert signal or the second alert signal only if the measured RSSI remains within one of the first range or the second range for a predetermined period of time.

7. A system comprising:
an indicia reader configured to communicate wirelessly with a host, the indicia reader having:
an imaging assembly for capturing image data over a field of view;
a decode module for receiving the image data and extracting a payload of an indicium present in the image data;
a reader wireless radio for transmitting the payload to the host;
a reader controller; and
a reader memory storing computer readable instructions that, when executed by the reader controller, cause the reader controller to:
determine a received signal strength indicator (RSSI) of a wireless signal between the indicia reader and the host;
responsive to the RSSI being within a first RSSI range associated with generating a first alert signal, at least one of (i) generating a first alert via an alert module of the indicia reader or (ii) transmitting a first alert message to the host; and
responsive to the RSSI being within a second RSSI range associated with generating a second alert signal, at least one of (i) generating a second alert via the alert module of the indicia reader or (ii) transmitting a second alert message to the host; and
the host communicatively coupled to the indicia reader, the host comprising:
a host wireless radio for receiving the payload from the indicia reader.

8. The system of claim 7, wherein the host further comprises:
a host controller; and
a host memory storing computer readable instructions that, when executed by the host controller, cause the host controller to:
responsive to receiving the first alert message from the indicia reader generating a first host-alert; and
responsive to receiving the second alert message from the indicia reader generating a second host-alert,
wherein the second host-alert is configured to be of greater intensity that the first host-alert.

9. The system of claim 7, wherein the host is a charging cradle configured to provide power to a rechargeable power source of the indicia reader.

10. The system of claim 7, wherein:
the first alert signal provides at least one of a first audible alert, a first visual alert, or a first haptic alert;
the second alert signal provides at least one of a second audible alert, a second visual alert, or a second haptic alert;
each of the second audible alert, the second visual alert, or the second haptic alert has a greater intensity than a respective one of the first audible alert, the first visual alert, or the first haptic alert.

11. The system of claim 7, wherein the second alert signal is configured to generate an alert of relatively higher intensity than first alert signal.

12. The system of claim 11, wherein the first RSSI range is further associated with a first distance range between the indicia reader and the host,
wherein the second RSSI range is further associated with a second distance range between the indicia reader and the host, and
wherein the second distance range extends over longer distances than the first distance range.

13. The system of claim 7, wherein the reader memory further stores computer readable instructions that, when executed by the reader controller, cause the reader controller to:
identify a transition to a measured RSSI being within one of the first range or the second range; and
responsively generating a respective one of the first alert signal or the second alert signal only if the measured RSSI remains within one of the first range or the second range for a predetermined period of time.

14. A system comprising:
an indicia reader configured to communicate wirelessly with a host, the indicia reader having:
an imaging assembly for capturing image data over a field of view;
a decode module for receiving the image data and extracting a payload of an indicium present in the image data;
a reader wireless radio for transmitting the payload to the host; and
the host communicatively coupled to the indicia reader, the host comprising:
a host wireless radio for receiving the payload from the indicia reader;
a host controller; and
a host memory storing computer readable instructions that, when executed by the host controller, cause the host controller to:
determine a received signal strength indicator (RSSI) of a wireless signal between the indicia reader and the host;
responsive to the RSSI being within a first RSSI range associated with generating a first alert signal, at least one of (i) generating a first alert via an alert module of the host or (ii) transmitting a first alert message to the indicia reader; and
responsive to the RSSI being within a second RSSI range associated with generating a second alert signal, at least one of (i) generating a second alert via the alert module of the host or (ii) transmitting a second alert message to the indicia reader.

15. The system of claim 14, wherein the host is a charging cradle configured to provide power to a rechargeable power source of the indicia reader.

16. The system of claim 14, wherein:
the first alert signal provides at least one of a first audible alert, a first visual alert, or a first haptic alert;
the second alert signal provides at least one of a second audible alert, a second visual alert, or a second haptic alert;
each of the second audible alert, the second visual alert, or the second haptic alert has a greater intensity than a respective one of the first audible alert, the first visual alert, or the first haptic alert.

17. The system of claim 14, wherein the second alert signal is configured to generate an alert of relatively higher intensity than the first alert signal.

18. The system of claim 17, wherein the first RSSI range is further associated with a first distance range between the indicia reader and the host,
wherein the second RSSI range is further associated with a second distance range between the indicia reader and the host, and
wherein the second distance range extends over longer distances than the first distance range.

19. The system of claim 14, wherein the host memory further stores computer readable instructions that, when executed by the host controller, cause the host controller to:
identify a transition to a measured RSSI being within one of the first range or the second range; and
responsively generating a respective one of the first alert signal or the second alert signal only if the measured RSSI remains within one of the first range or the second range for a predetermined period of time.

20. A method of generating an alert responsive to an indicia reader and a host being positioned within a range of each other, the indicia reader being wirelessly coupled to the host, the method comprising:
determining a received signal strength indicator (RSSI) of a wireless signal between the indicia reader and the host;
responsive to the RSSI being within a first RSSI range associated with generating a first alert signal, at least one of (i) generating a first reader alert via an alert module of the indicia reader or (ii) generating a first host alert via an alert module of the host; and
responsive to the RSSI being within a second RSSI range associated with generating a second alert signal, at least one of (i) generating a second reader alert via the alert module of the indicia reader or (ii) generating a second host alert via the alert module of the host.

21. The method of claim 20, wherein the second alert signal is configured to generate an alert of relatively higher intensity than the first alert signal.

22. The system of claim 21, wherein the first RSSI range is further associated with a first distance range between the indicia reader and the host,
wherein the second RSSI range is further associated with a second distance range between the indicia reader and the host, and
wherein the second distance range extends over longer distances than the first distance range.
